(19) United States
(12) Patent Application Publication
(10) Pub. No.: US 2024/0014398 A1
(43) Pub. Date: Jan. 11, 2024

(54) ELECTRODE INCLUDING POLYMER FIBER AGGREGATE AND MANUFACTURING METHOD THEREOF

(71) Applicants: Hyundai Motor Company, Seoul (KR); Kia Corporation, Seoul (KR); Gwangju Institute of Science and Technology, Gwangju (KR)

(72) Inventors: Byung Hong Lee, Suwon (KR); Kyoung Han Ryu, Yongin (KR); Ri Ra Kang, Uiwang, (KR); Myung Han Yoon, Gwangju (KR); Young Seok Kim, Gwangju (KR)

(21) Appl. No.: 18/084,222

(22) Filed: Dec. 19, 2022

(30) Foreign Application Priority Data
Jul. 6, 2022 (KR) 10-2022-0082891

(51) Int. Cl. H01M 4/62; H01M 4/04; D01D 5/06; D01F 6/94; H01G 11/86; H01G 11/48; H01G 11/24; H01G 11/26

(52) U.S. Cl. CPC H01M 4/624; H01M 4/0419; D01D 5/06; D01F 6/94; H01G 11/86; H01G 11/48; H01G 11/24; H01G 11/26; H01M 2004/021

(57) ABSTRACT

Disclosed is an electrode including a polymer fiber aggregate and a manufacturing method thereof. The electrode may be used in a capacitor and include a cut conductive polymer fiber and pores therein to increase a specific surface area even when the thickness is increased, thereby increasing ion conductivity and improving energy power and a manufacturing method thereof.

### CROSS-REFERENCE TO RELATED APPLICATION

The present application claims priority to Korean Patent Application No. 10-2022-0082891, filed Jul. 6, 2022, the entire contents of which is incorporated herein for all purposes by this reference.

### TECHNICAL FIELD

The present disclosure relates to an electrode including a polymer fiber aggregate and a manufacturing method thereof. The electrode may be used for a capacitor and include cut conductive polymer fibers and pores which increase a specific surface area of the electrode even when the electrode has an increased thickness, thereby increasing ion conductivity and improving output power.

### BACKGROUND

Supercapacitors have a power density of 10⁴ W/kg, which is much greater than that of a secondary battery and have very fast charging and discharging rates. The charging/discharging time is very fast, and the lifespan is almost semi-permanent. However, in terms of energy density, the energy density is about 30 Wh/g, which does not reach the energy density (50 Wh/g or more) of a Li battery. Therefore, supercapacitors are used as an energy source for devices that require high power/high energy density rather than general-purpose circuit components. In particular, research has been conducted to be applied to applications that require instantaneous high output power or long life, such as electric vehicles, power tools, uninterruptible power supplies, and copiers. However, the search for new active material for improving the performance of a supercapacitor having a fast charge/discharge time may be one of the important research areas in response to the need for improvement on the problem of slow charging of electric vehicles.

On the other hand, a supercapacitor is composed of a current collector, an active material (electrode), an electrolyte, and a porous active material with a large surface area having high capacitance and electrical conductivity capable of delivering sufficient energy to the current collector may be required. Carbon material, metal oxide, conductive polymer, and composite thereof are used as active materials, but each has advantages and disadvantages.

Conventional carbon material-based supercapacitors have been manufactured using porous carbon materials at the level of several to tens of nanometers with a large surface area while being inexpensive and thus may have high capacitance per unit volume. However, during repeated charging and discharging, restocking of the carbon material occurs, and as a result, ion permeability is rapidly reduced and thus there is a problem in that the electrochemical properties have deteriorated.

A conductive polymer-based supercapacitor has been developed to solve the problem in the related art. For example, high electrochemical characteristics of the conductive polymer can be induced by oxidation/reduction. Some conductive polymers have volume capacitance by ion permeability, thereby enabling large capacity. Conductive polymers used in supercapacitor research may include polyaniline (PANi), poly(3,4-ethylenedioxythiophene) (PEDOT), polypyrrole (PPy), and polythiophene (PTh). Conductive polymers have a specific capacitance of 100 to 300 F/g, similar to carbon materials, and are attracting attention because of the possibility of manufacturing flexible capacitors through a roll-to-roll process. However, due to the limited ion permeability of the conductive polymer, characteristics of the conductive polymer have rapidly deteriorated at a thickness of tens to hundreds of nanometers or more. Therefore, supercapacitors have been generally manufactured in a structure in which unit structures having active layers and current collectors of tens to hundreds of nanometers are repeatedly stacked, and as a result, an actual capacitance is decreased due to an increase in volume due to a current collector.

In this regard, although composite with a metal oxide (MnO₂) having a high capacitance or graphene having excellent conductivity has been attempted, satisfactory results in terms of capacitance have not been obtained yet. Recently, technology for manufacturing conductive polymers into porous structures has been developed, but the effect has been insufficient due to relatively low ion permeability and non-uniformity. In addition, since a large amount of nanofiller is required to obtain high capacitance, the nanofiller is not reaching a lithium battery in terms of energy density.

### SUMMARY

In preferred aspects, provided is an electrode used for capacitors that do not degrade characteristics even if the thickness of the electrode increases. Further, the electrode for a capacitor may have a structure capable of improving the power/energy density per unit mass.

The objective of the present disclosure is not limited to the objective mentioned above. The objectives of the present disclosure will become clearer from the following description and will be realized by means and combinations thereof described in the claims.

In an aspect, provided is a method for an electrode that may include: producing a polymer network by spinning a spinning solution including a conductive polymer material into a sulfuric acid solution; preparing polymer fragments by pulverizing the polymer network; preparing an admixture including the polymer fragments; and aggregating the polymer fragments to form the polymer fiber aggregate. In particular, the polymer fiber aggregate may include pores therein.

The conductive polymer material may include poly(3,4-ethylenedioxythiophene) polystyrene sulfonate (PEDOT:PSS). Preferably poly(3,4-ethylenedioxythiophene) polystyrene sulfonate (PEDOT:PSS) is a polymer mixture of two ionomers. One component in this mixture is made up of sodium polystyrene sulfonate which is a sulfonated polystyrene. Part of the sulfonyl groups are deprotonated and carry a negative charge. The other component poly(3,4-ethylenedioxythiophene) (PEDOT) is a conjugated polymer and carries positive charges and is based on polythiophene. Together the charged macromolecules form a macromolecular salt.

The conductive polymer material may include the poly(3,4-ethylenedioxythiophene)(PEDOT) and the polystyrene sulfonate (PSS) in a molar ratio of about 1:0.1 to 1:0.4.

The spinning solution may be wet-spun in the form of fibers to a coagulation bath, and the form of fibers spun from the spinning solution may be irregularly stacked in the coagulation bath to form a polymer network.

The spinning solution may be coagulated to form polymer fibers, and the polymer network may include irregularly stacked polymer fibers.

The diameter size of the polymer fiber may be in a range of about 1.01 μm to 100 μm.

The polymer network may be pulverized by physical impact to form a pulverized polymer.

The pulverized polymer may include cut polymer fibers.

The manufacturing method may aggregate the pulverized polymer while removing a liquid component from the admixture.

The liquid component may include an organic solvent, and the organic solvent may be removed by filtering or spraying the admixture.

The method may further include washing the polymer fiber aggregate with a solvent component (e.g., water) after forming the polymer fiber aggregate.

The admixture may be performed by spray-coating on a substrate being transported to manufacture a film including a polymer fiber aggregate.

In an aspect, provided is an electrode manufactured by the methods as described herein.

In an aspect, provided is an electrode including polymer fibers, including a conductive polymer material, may be irregularly aggregated and the electrode may include pores therein.

The polymer fiber may have a length in a range of about 1 to 1,000 mm, and a diameter of about 1.0 to 100 μm.

The porosity of the electrode may be about 1% to 10%.

The specific surface area of the electrode may be in a range of about 30 to 1,000 m²/g.

The electrode may have a thickness in a range of about 10 to 1,000 nm.

The specific capacitance of the electrode may be in a range of about 60 to 100 F/g.

Also provided is a battery (e.g., secondary battery or lithium ion battery) including the electrode as described herein.

Further provided is a vehicle that includes the battery as described above.

According to various exemplary embodiments of the present disclosure, an electrode for capacitors that do not degrade characteristics even if the thickness of the electrode increases can be provided.

According to various exemplary embodiments of the present disclosure, the electrode may be used as a capacitor having a structure capable of improving the power/energy density per unit mass.

Other aspects of the invention are disclosed infra.

### BRIEF DESCRIPTION OF THE DRAWINGS

FIG. 1 shows a flow chart for an exemplary electrode manufacturing method according to an exemplary embodiment of the present disclosure;

FIG. 2 shows a process diagram for each step of manufacturing the electrode according to an exemplary embodiment of the present disclosure;

FIG. 3 shows an enlarged view of an exemplary polymer fiber aggregate included in an exemplary electrode according to an exemplary embodiment of the present disclosure;

FIG. 4 shows an exemplary electrode of a production example produced by applying different amounts of polymer fibers included in the electrode;

FIG. 5 shows the change in the surface resistance value according to the areal density of the electrode;

FIG. 6 shows the values of specific capacitance according to the areal density of the electrode;

FIG. 7 shows a graph of a charge/discharge curve according to the surface density of the electrode;

FIG. 8 shows capacitance values according to the surface density of an electrode; and

FIG. 9 shows capacitance values according to current density.

### DETAILED DESCRIPTION

The above objectives, other objectives, features, and advantages of the present disclosure will be easily understood through the following preferred embodiments in conjunction with the accompanying drawings. However, the present disclosure is not limited to the embodiments described herein and may be embodied in other forms. Rather, the embodiments introduced herein are provided so that the disclosed content may be thorough and complete, and the spirit of the present disclosure may be sufficiently conveyed to those skilled in the art.

Like reference numerals have been used for like elements in describing each figure. In the accompanying drawings, the dimensions of the structures are enlarged than the actual size for clarity of the present disclosure. Terms such as first, second, etc., may be used to describe various elements, but the elements should not be limited by the terms. The above terms are used only for the purpose of distinguishing one component from another. For example, without departing from the scope of the present disclosure, a first component may be referred to as a second component, and similarly, a second component may also be referred to as a first component. The singular expression includes the plural expression unless the context clearly dictates otherwise.

In this specification, the terms “include” or “have” should be understood to designate that one or more of the described features, numbers, steps, operations, components, or a combination thereof exist, and the possibility of addition of one or more other features or numbers, operations, components, or combinations thereof should not be excluded in advance. Also, when a part of a layer, film, region, plate, etc., is said to be “on” another part, this includes not only the case where it is “on” another part but also the case where another part is in the middle. Conversely, when a part of a layer, film, region, plate, etc., is said to be “under” another part, this includes not only cases where it is “directly under” another part but also a case where another part is in the middle.

Unless otherwise specified, all numbers, values, and/or expressions expressing quantities of ingredients, reaction conditions, polymer compositions, and formulations used herein contain all numbers, values, and/or expressions in which such numbers essentially occur in obtaining such values, among others. Since they are approximations reflecting various uncertainties in the measurement, it should be understood as being modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when a numerical range is disclosed in this disclosure, this range is continuous and includes all values from the minimum to the maximum value containing the maximum value of this range unless otherwise indicated. Furthermore, when such a range refers to an integer, all integers, including the minimum value to the maximum value containing the maximum value, are included unless otherwise indicated. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Provided, inter alia, are to an electrode including a polymer fiber aggregate and a manufacturing method thereof.

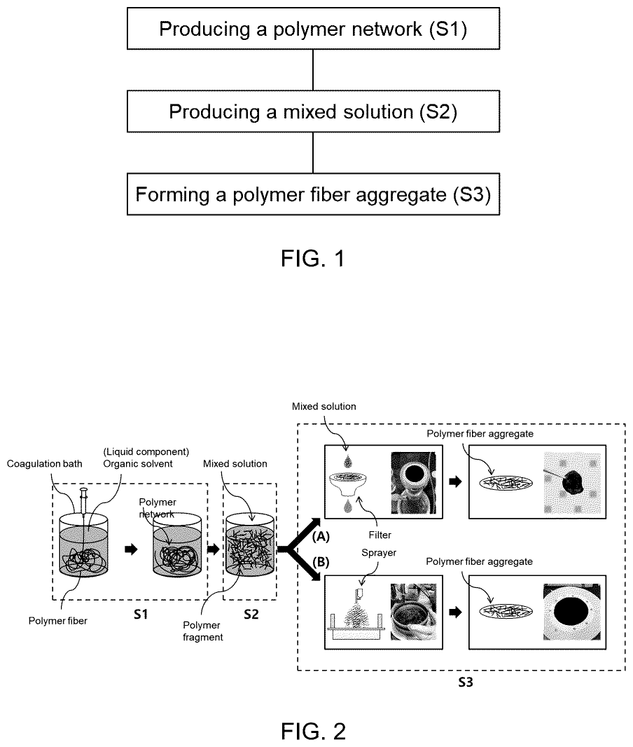

FIGS. 1 and 2 show a flow chart and a process diagram for an exemplary manufacturing method for an electrode according to exemplary embodiments of the present disclosure, and the manufacturing method for an electrode of the present disclosure will be described with reference to this, and then the electrode of the present disclosure will be described.

The manufacturing method for an electrode of the present disclosure may include: producing a polymer network by spinning (e.g., wet-spinning) a spinning solution including a conductive polymer material into a sulfuric acid solution; preparing polymer fragments by pulverizing the polymer network;

preparing an admixture including the polymer fragments; and forming a polymer fiber aggregate by aggregating the polymer fragments.

Hereinafter, each step will be described with reference to FIGS. 1 and 2.

Step S1: Producing Polymer Network

A polymer network may be prepared by spinning (e.g., wet spinning) a spinning solution including a conductive polymer material into a sulfuric acid solution. The spinning solution is suitably be wet-spun into a sulfuric acid solution.

As shown in FIG. 2, the spinning solution may be wet-spun in the form of fibers into a coagulation bath, and the spinning solution spun in the form of fibers may be coagulated to produce polymer fibers. At this time, the spinning solution spun in the form of fibers may be irregularly stacked in the coagulation bath to form a polymer network.

Particularly, the polymer network includes irregularly stacked polymer fibers.

The spinning solution includes a conductive polymer material and a liquid component, and the liquid component may include an organic solvent.

The conductive polymer material may preferably include poly(3,4-ethylenedioxythiophene):polystyrene sulfonate (PEDOT:PSS). More preferably, the conductive polymer material includes the poly(3,4-ethylenedioxythiophene) (PEDOT) and the polystyrene sulfonate (PSS) in a molar ratio of about 1:0.1 to 1:0.4.

The organic solvent may include a polar organic solvent with low reactivity, and may include, for example, acetone.

The coagulation bath may be filled with the sulfuric acid solution, and the concentration of sulfuric acid solution may be preferably in a range of about 30 vol % or greater.

The spinning of the spinning solution may be performed through a syringe including a nozzle, and the diameter of the polymer fiber may be adjusted through the diameter size and spinning pressure of the nozzle.

The diameter of the polymer fiber is preferably in a range of about 1.0 to 100 more preferably about 2.5 to 20 μm.

A polymer network is formed through the stack and aggregation of the polymer fibers.

Step S2: Producing an Admixture

An admixture may be prepared by including a polymer fragments, which is prepared by pulverizing the polymer network.

The polymer network immersed in the sulfuric acid solution in the coagulation bath may be pulverized by a physical impact. The method of applying the physical impact is not particularly limited. However, any method can be used as long as the polymer fiber included in the polymer network can be cut to a very short length and evenly dispersed in the sulfuric acid solution.

Particularly, the pulverized polymer material preferably may include cut polymer fibers, in which the polymer fiber may have a length in a range of about 1 to 1,000 mm.

Step S3: Formation of Polymer Fiber Aggregate

The pulverized polymer material may be aggregated to form a polymer fiber aggregate. The polymer fibers may be aggregated by removing the liquid component including the organic solution except for the polymer fibers from the mixed solution including the cut polymer fibers.

The liquid component may be removed by filtering or spraying the mixed solution. At this time, aggregation of the polymer fibers occurs simultaneously with the removing the liquid component.

In FIG. 2, the process of forming the polymer fiber aggregate may be divided into method (A) for producing a polymer fiber aggregate through a filter and method (B) for producing a polymer fiber aggregate through a sprayer.

The filtration method (A) may include filtering the polymer fibers through a filtration network, etc., and allowing the remaining solution to pass through the filtration network. Alternatively, a vacuum filtration method may be preferably used, and the polymer fibers filtered through the filtration are loaded to control the thickness of the electrode.

The spraying method (B) may include a step in which the mixed solution may be sprayed through a spraying device so that the polymer fiber is attached to a substrate and the liquid component is blown away in the air. Preferably, the mixed solution is sprayed onto the vacuum chuck to aggregate the polymer fibers. At this time, the thickness of the electrode can be controlled by spraying the polymer fibers on the substrate.

The spraying method (B) may be applied to a roll-to-roll process. For example, a polymer fiber aggregate having a predetermined interval and thickness can be produced by continuously spraying the admixture on the substrate transported through a roll, in which the polymer fiber aggregate is continuously produced in the form of a film.

After forming the polymer fiber aggregate, washing the polymer fiber aggregate with water or drying the polymer fiber aggregate may be further included, and the liquid component may be completely removed from the polymer fiber aggregate.

The electrode may thus include a polymer fiber aggregate, and the polymer fiber aggregate preferably includes pores therein.

Electrode

The electrode may include polymer fibers that include a conductive polymer material and e irregularly aggregated, and include pores therein.

The electrode may be preferably produced by the manufacturing method for the electrode of the present disclosure described above.

The conductive polymer material preferably may include poly(3,4-ethylenedioxythiophene):polystyrene sulfonate) (PEDOT:PSS)

The polymer fiber preferably has a length in a range of about 1 to 1,000 mm, and a diameter of about 1.0 to 100 μm.

The porosity of the electrode may be preferably about 1% to 10%.

The specific surface area of the electrode may be preferably in a range of about 30 to 1,000 m²/g.

The electrode preferably may have a thickness in a range of about 10 to 1,000 nm.

The electrode may be preferably used as an electrode for a supercapacitor and very preferably has a specific capacitance in a range of about 60 to 100 F/g and a fiber conductivity of about 1000 S/cm or less.

### EXAMPLE

Hereinafter, the present disclosure will be described in more detail through specific Examples. However, the Examples of the present disclosure are intended to illustrate the present disclosure, and the scope of the present disclosure is not limited or limited thereby.

### Production Example

A spinning solution including poly(3,4-ethylenedioxythiophene):polystyrene sulfonate (PEDOT:PSS) and acetone was spun into the sulfuric acid solution at a concentration of 30 vol % to produce a polymer network, and the polymer network was pulverized with a mixer to produce an admixture.

Then, the admixture was sprayed on the vacuum chuck through a spray coating device to produce an electrode having a large area of 6 inches in diameter. At this time, the diameter of the polymer fiber included in the electrode was about 10 μm.

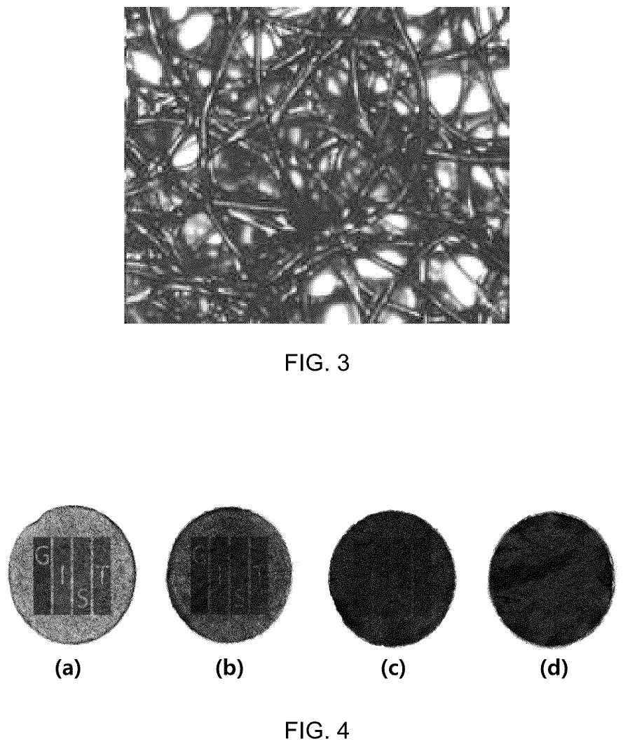

FIG. 3 shows an enlarged view of the produced electrode, irregularly entangled polymer fibers were aggregated to form a polymer fiber aggregate, and pores formed between the polymer fibers were confirmed.

Meanwhile, each experiment to be described later was performed by varying the content of the polymer fiber included in the electrode from 0.2 to 5 mg/cm².

FIG. 4 shows the results of measuring the light transmittance by changing the content of the polymer fiber. The content of the polymer fiber increased from the left side to the right side of FIG. 4. The permeability decreased as the content of the polymer fiber increased.

### Experimental Example 1

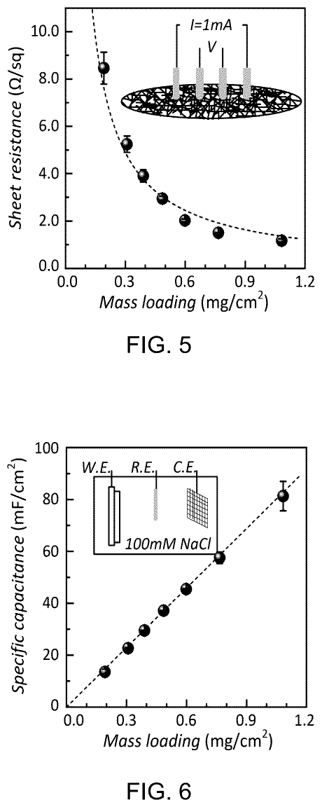

The surface resistance was measured for the electrode of the Preparation Example, and the result is shown in FIG. 5. As shown in FIG. 5, as the content of the polymer fiber included in the electrode increased, the surface resistance value dropped from 8 ohm/sq to 1.0 ohm/sq. This means that as a dense network is formed, high performance can be obtained in the electron movement surface, and accordingly, higher storage efficiency can be implemented.

### Experimental Example 2

Specific capacitance was measured with respect to the electrode of the Preparation Example, and the results are shown in FIG. 6. As shown in FIG. 6, the electrode had greater storage efficiency of about 80 mF/cm 2 when measuring the storage performance as well as the high electron mobility.

### Experimental Example 3

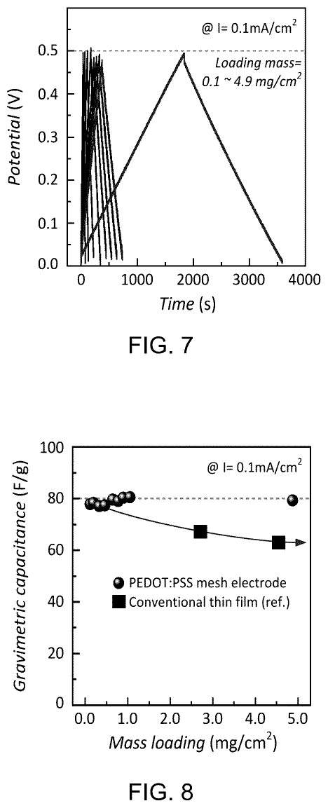

Charging and discharging experiments were performed on the electrodes of the Preparation Example, and the results are shown in FIG. 7. FIG. 7 shows a charging/discharging curve when the electrode was charged and discharged at a constant current. Thus, the higher the content of the polymer fiber, the better the charging/discharging performance.

### Experimental Example 4

Capacitance was measured with respect to the electrode of the Preparation Example, and the result is shown in FIG. 8. As shown in FIG. 8, the capacitance per mass of the polymer fiber, according to an exemplary embodiment of the present disclosure, was maintained even at a high loading amount as compared to a conventional electrode. Thus, no degradation in characteristics was shown due to micropores compared to the case of the thin film sample implemented in the same material configuration.

### Experimental Example 5

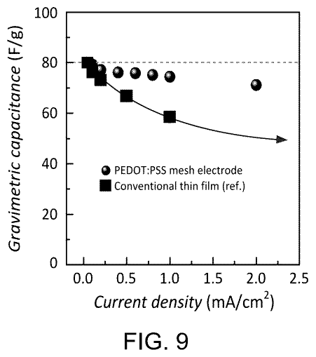

The capacitance was measured by adjusting the current density to 0.1 to 2 mA/cm 2 in the electrode of the Preparation Example, and the results are shown in FIG. 9. For the specimen with a high content of polymer fibers, which showed the worst results in FIG. 9, the electrode, according to an exemplary embodiment of the present disclosure, exhibited a decrease in capacitance of about 10% at a high current density, which is the effect of the thickness of the microfiber itself. However, when compared with the results of the existing thin film samples, the effect was insignificant.

Although the exemplary embodiments of the present disclosure has been described with reference to the accompanying drawings, it will be understood by those skilled in the art that the present disclosure may be implemented in other specific forms without changing the technical spirit or essential features thereof. Therefore, it should be understood that the embodiments described above are illustrative in all respects and not restrictive.

What is claimed is:

1. A method of manufacturing an electrode, comprising:
producing a polymer network by spinning a spinning solution comprising a conductive polymer material into a sulfuric acid solution;
preparing polymer fragments by pulverizing the polymer network;
producing an admixture comprising the polymer fragments; and
forming a polymer fiber aggregate by aggregating the polymer fragments, wherein the polymer fiber aggregate has pores therein.

2. The method of claim 1, wherein the conductive polymer material comprises poly(3,4-ethylenedioxythiophene):polystyrene sulfonate (PEDOT:PSS).

3. The method of claim 2, wherein the conductive polymer material comprises the poly(3,4-ethylenedioxythiophene)(PEDOT) and the polystyrene sulfonate (PSS) in a molar ratio of about 1:0.1 to 1:0.4.

4. The method of claim 1, wherein the spinning solution is wet-spun in the form of fibers to a coagulation bath, and the fibers spun from the spinning solution are irregularly stacked in the coagulation bath to form the polymer network.

5. The method of claim 1, wherein the spinning solution is coagulated to form a polymer fiber, and the polymer fiber is irregularly stacked in the coagulation bath to form the polymer network.

6. The method of claim 5, wherein the polymer fiber has a diameter in a range of about 1.0 to 100 μm.

7. The method of claim 1, wherein the polymer network is pulverized by physical impact to form the polymer fragments.

8. The method of claim 5, wherein the polymer fragments comprise cut polymer fibers.

9. The method of claim 1, wherein the polymer fragments are aggregated while removing a liquid component from the admixture.

10. The method of claim 9, wherein the liquid component is removed by filtering or spraying the admixture.

11. The method of claim 1, wherein the method further comprises:
washing the polymer fiber aggregate with a solvent component after the forming of the polymer fiber aggregate.

12. The method of claim 1, wherein the admixture is sprayed to a moving substrate so that a film comprising the polymer fiber aggregate is formed on the moving substrate.

13. An electrode comprising polymer fibers comprising a conductive polymer material and being irregularly aggregated, wherein the electrode comprises pores.

14. The electrode of claim 13, wherein the conductive polymer material comprises poly(3,4-ethylenedioxythiophene):polystyrene sulfonate (PEDOT:PSS).

15. The electrode of claim 13, wherein the polymer fiber has a length in a range of about 1 to 1,000 mm and a diameter in a range of about 1.0 to 100 μm.

16. The electrode of claim 13, wherein the electrode has a porosity in a range of about 1% to 10%.

17. The electrode of claim 13, wherein the electrode has a specific surface area in a range of about 30 to 1,000 m²/g.

18. The electrode of claim 13, wherein the electrode has a thickness in a range of about 10 to 1,000 nm.

19. The electrode of claim 13, wherein the electrode has a specific capacitance in a range of about 60 to 100 F/g.

20. A battery comprising the electrode of claim 13.
